(19) United States
(12) Patent Application Publication
(10) Pub. No.: US 2013/0083395 A1
(43) Pub. Date: Apr. 4, 2013

(54) Screen Protector

(71) Applicant: Chun-Lin Liu, Tainan City (TW)

(72) Inventor: Chun-Lin Liu, Tainan City (TW)

(21) Appl. No.: 13/252,246

(22) Filed: Oct. 4, 2011

(51) Int. Cl. G02B 27/00

(52) U.S. Cl. 359/507

(57) ABSTRACT

A screen protector includes inner and outer PET films, a printed black-frame film, a PET release film, and a PE protective film. The inner PET film has a printed peripheral area for electrostatic attraction and a transparent central area. The printed black-frame film has a frame-like peripheral area coated in the desired color and shaped as the printed peripheral area of the inner PET film. The inner PET film, the printed black-frame film, and the outer PET film are sequentially bonded, before the PET release film and the PE protective film are bonded to the inner and outer PET films respectively. The screen protector can be cut to size and formed with holes at predetermined positions. To apply the screen protector to a screen, the PET release film is peeled off, allowing the printed peripheral area of the inner PET film to attach compliantly to the screen by electrostatic attraction.

### BACKGROUND OF THE INVENTION

1. Technical Field

The present invention relates to screen protectors and, more particularly, to a screen protector applicable to the screen of a portable information or communication device, wherein the screen protector not only can be rapidly applied to the screen in a completely compliant manner, but also has an optional privacy protection film to prevent the screen images from being furtively viewed.

2. Description of Related Art

Recently, the market has been supplied with more and more portable information or communication devices that are configured for multiple functions such as Internet connection, movie and music playback, eBook reading, map services, and games. Some notable examples of such devices are iPad, iPhone, and MacBook. These portable devices have brought about tremendous convenience in people's daily lives.

In order to protect the screens of the foregoing information or communication devices against scratching, it is now common practice to apply additional screen protectors to the screens. However, commercially available screen protectors are so configured that, if a screen protector is improperly applied, bubbles are very likely to form between the screen protector and the screen. This is why most people leave the application of screen protectors to the professionals. And because of that, one who wishes to protect the screen of a portable device not only has to buy a screen protector of the appropriate size, but also has to spend extra money so that the screen protector is attached to the screen by a professional.

Apart from that, when people use the aforesaid information or communication devices in public places (e.g., on a train, onboard an airplane, in an office, etc.), passers-by tend glance at or view the contents displayed by the devices, simply out of curiosity. However, if the contents displayed are not intended to be shared, then the device users' privacy is infringed.

To solve the privacy infringement problem, privacy protection films to be applied to the screens of iPad, iPhone, MacBook, and the like were developed to prevent those other than the users themselves from viewing the screen images. After a privacy protection film is attached to a screen, only the user—the one in front of the screen—can view the screen images clearly; the screen will turn black to those viewing from the sides. Thus, with a user-only viewing angle of about 120 degrees, privacy protection is ensured.

To apply such a privacy protection film to a screen, it is generally required to peel off the release paper of a plurality of small fixing pads, adhere the fixing pads along the periphery of the screen, and then attach the privacy protection film, which is cut to size in advance, to the fixing pads, such that the privacy protection film lies between the fixing pads provided around the periphery of the screen and covers the screen. Once the privacy protection film is in place, the contents displayed on the screen are protected from view by passers-by, and the user's privacy is secured.

Nevertheless, the application of privacy protection films has the following drawbacks:

1. A privacy protection film cannot be attached to a screen without the plurality of small fixing pads, and yet the combined thickness of the privacy protection film and the fixing pads is esthetically undesirable.

2. As the privacy protection film is not compliantly applied to the screen, the gap therebetween tends to compromise the view of the screen.

### BRIEF SUMMARY OF THE INVENTION

The present invention provides an improvement over the existing screen protectors that are designed to be applied to the screens of certain devices. More particularly, the improvement is targeted at the inconvenient application of screen protectors or privacy protection films. It is highly desirable that a screen protector or privacy protection film can be easily and rapidly applied to a screen in a completely compliant manner.

The first primary object of the present invention is to provide a screen protector applicable to the screen of a portable information or communication device, wherein the screen protector includes an inner polyethylene terephthalate (PET) film, a printed black-frame film, an outer PET film, a PET release film, and a polyethylene (PE) protective film. The inner PET film has a printed peripheral area capable of electrostatic attraction and a transparent central area. The printed black-frame film has a frame-like peripheral area coated in the desired color and shaped according to the printed peripheral area of the inner PET film. The inner PET film, the printed black-frame film, and the outer PET film are sequentially bonded, before the PET release film is bonded to the outer side of the inner PET film, and the PE protective film to the outer side of the outer PET film. The screen protector can be cut according to the size of the screen to be protected and can also be formed with holes at predetermined positions. To apply the screen protector to a screen, the PET release film is peeled off, and then the inner PET film is attached to the screen by electrostatic attraction between the screen and the printed peripheral area of the inner PET film. By doing so, the screen protector is allowed to be applied to the screen in a completely compliant manner, without bubbles formed therebetween.

The second object of the present invention is to provide the foregoing screen protector, wherein the outer side of the outer PET film is further bonded with a hardened layer so that the screen protector provides enhanced anti-scratch protection to the screen being protected.

The third object of the present invention is to provide the foregoing screen protector, wherein the outer PET film is a transparent film.

The fourth object of the present invention is to provide the foregoing screen protector, wherein the outer PET film is a matte film.

The second primary object of the present invention is to provide a screen protector capable of privacy protection and applicable to the screen of a portable information or communication device, wherein the screen protector includes a PET film, a printed black-frame film, a privacy protection film, a PET release film, and a PE protective film. The PET film has a printed peripheral area capable of electrostatic attraction and a transparent central area. The printed black-frame film has a frame-like peripheral area coated in the desired color and shaped according to the printed peripheral area of the PET film. The PET film, the printed black-frame film, and the privacy protection film are sequentially bonded, before the PET release film is bonded to the outer side of the PET film, and the PE protective film to the outer side of the privacy protection film. The screen protector capable of privacy protection can be cut according to the size of the screen to be protected and can also be formed with holes at predetermined positions. To apply the screen protector to a screen, the PET release film is peeled off, and then the PET film is attached to the screen by electrostatic attraction between the screen and the printed peripheral area of the PET film. Thus, the screen protector capable of privacy protection is applied conveniently and compliantly to the screen and can be removed as easily when not in use.

The sixth object of the present invention is to provide the foregoing screen protector capable of privacy protection, wherein the outer side of the privacy protection film is further bonded with a hardened layer so that the screen protector provides enhanced anti-scratch protection to the screen being protected.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is an exploded perspective view of a screen protector according to the present invention;

FIG. 2 is a sectional view of the screen protector depicted in FIG. 1;

FIG. 3 is a perspective view of the screen protector depicted in FIG. 1 and a tablet PC to which the screen protector is to be applied;

FIG. 4 is a perspective view showing the screen protector depicted in FIG. 1 applied to the tablet PC depicted in FIG. 3;

FIG. 5 is an exploded perspective view of another screen protector of the present invention that is capable of privacy protection;

FIG. 6 is a sectional view of the screen protector depicted in FIG. 5;

FIG. 7 is a perspective view of the screen protector depicted in FIG. 5 and a tablet PC to which the screen protector is to be applied;

FIG. 8 is a perspective view showing the screen protector depicted in FIG. 5 applied to the tablet PC depicted in FIG. 7; and

FIG. 9 schematically shows a tablet PC in use, wherein the tablet PC is attached with the screen protector depicted in FIG. 5.

### DETAILED DESCRIPTION OF THE INVENTION

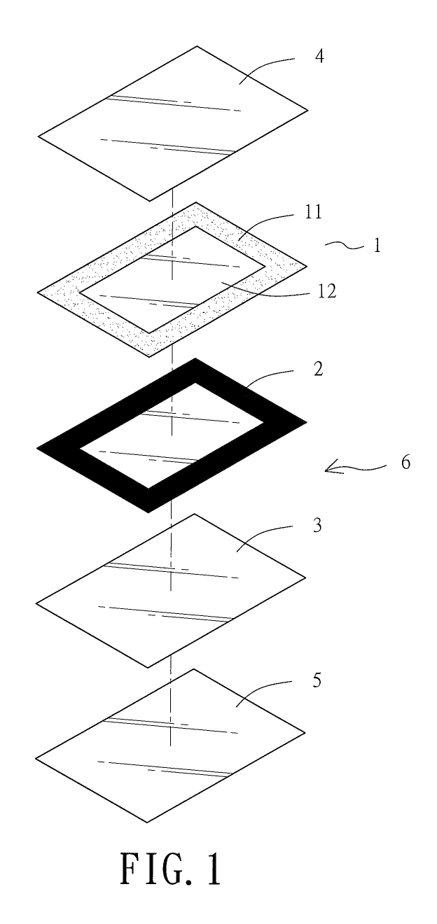

Referring to FIG. 1, a screen protector 6 in accordance with the present invention is designed to be applied to the screen of a portable information or communication device such as iPad, iPhone, and MacBook. The screen protector 6 includes an inner polyethylene terephthalate (PET) film 1, a printed black-frame film 2, an outer PET film 3, a PET release film 4, and a polyethylene (PE) protective film 5.

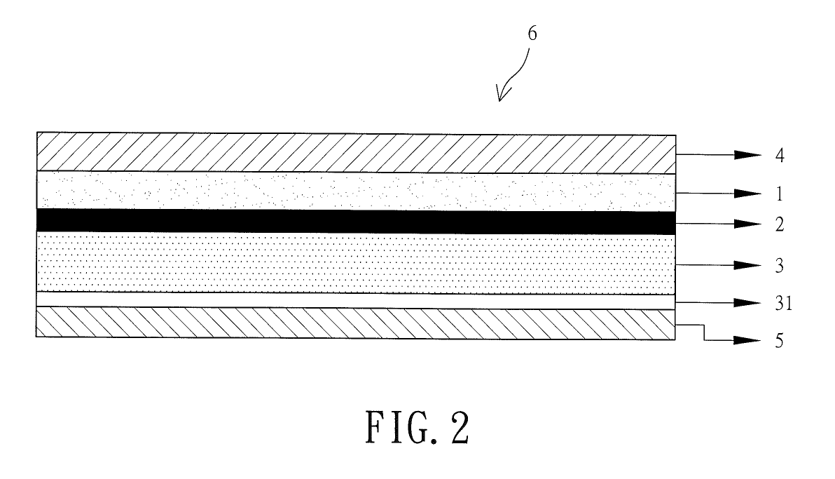

The inner PET film 1 has a printed area 11 around its periphery, and the printed area 11 is capable of electrostatic attraction. Meanwhile, the central portion of the inner PET film 1 remains a transparent area 12. The printed black-frame film 2 has a frame-like peripheral area that is coated in the desired color and shaped according to the printed area 11 around the periphery of the inner PET film 1. It should be pointed out that the desired color is not necessarily black; it can be the color of the housing of a device to which the screen protector 6 is to be applied or a different color. The outer PET film 3 can be either transparent or matte. To form the screen protector 6, referring to FIG. 2, the inner PET film 1 and the outer PET film 3 are bonded to opposite sides of the printed black-frame film 2 respectively, and then the PET release film 4 and the PE protective film 5 are bonded to the outer side of the inner PET film 1 and the outer side of the outer PET film 3 respectively.

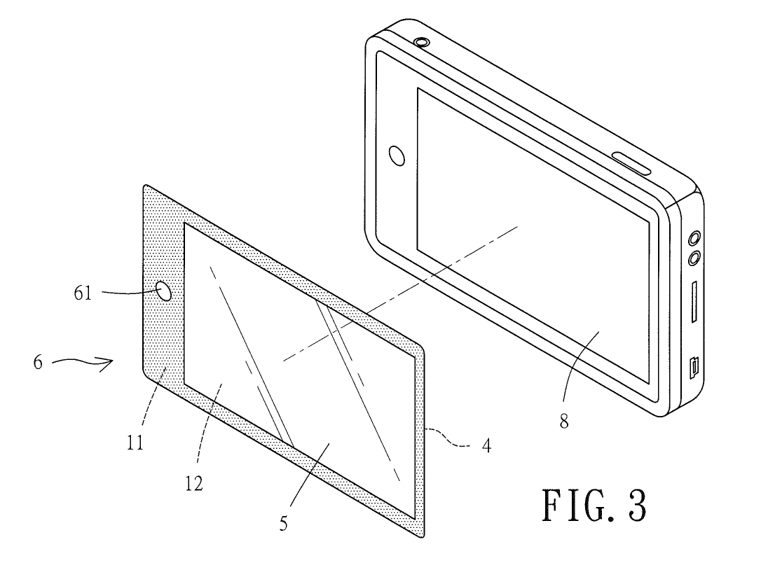

As shown in FIG. 2, the outer side of the outer PET film 3 can be further bonded with a hardened layer 31. Thus, once the screen protector 6 is applied to a screen 8 (see FIG. 3), the hardened layer 31 provides enhanced anti-scratch protection to the screen 8.

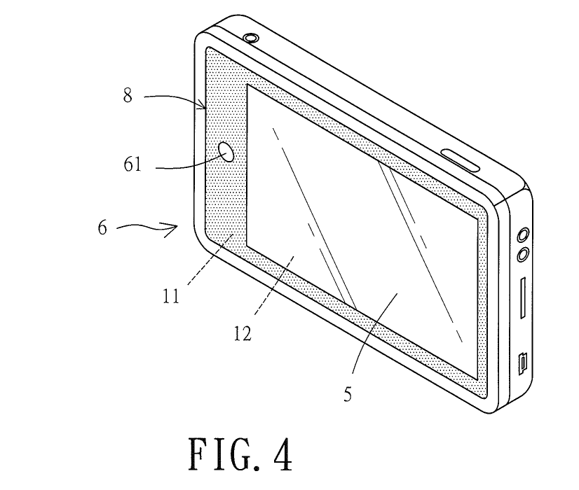

Referring to FIG. 3, the screen protector 6 can be cut and trimmed according to the size of the screen 8 (e.g., the screen of an iPad). It is also feasible to form a hole 61 at a predetermined position of the screen protector 6. To apply the screen protector 6 to the screen 8, the PET release film 4 is peeled off, and the inner PET film 1 thus exposed is attached to the screen 8 by electrostatic attraction between the screen 8 and the printed area 11 around the periphery of the inner PET film 1, as shown in FIG. 4. By doing so, the screen protector 6 can comply completely with the screen 8, and no bubbles will be formed between them. After that, the PE protective film 5 on the outer side of the screen protector 6 is peeled off to allow a clearer view of the screen 8, which is now covered with the inner PET film 1, the printed black-frame film 2, and the outer PET film 3 and hence well protected against surface scratch.

If, upon reuse or reapplication of the screen protector 6, electrostatic attraction of the inner PET film 1 weakens to such extent that the screen protector 6 cannot be attached to a screen, the user only has to rub the inner PET film 1 or wash it with water, and the printed area 11 around the periphery of the inner PET film 1 will become electrostatically attractive again.

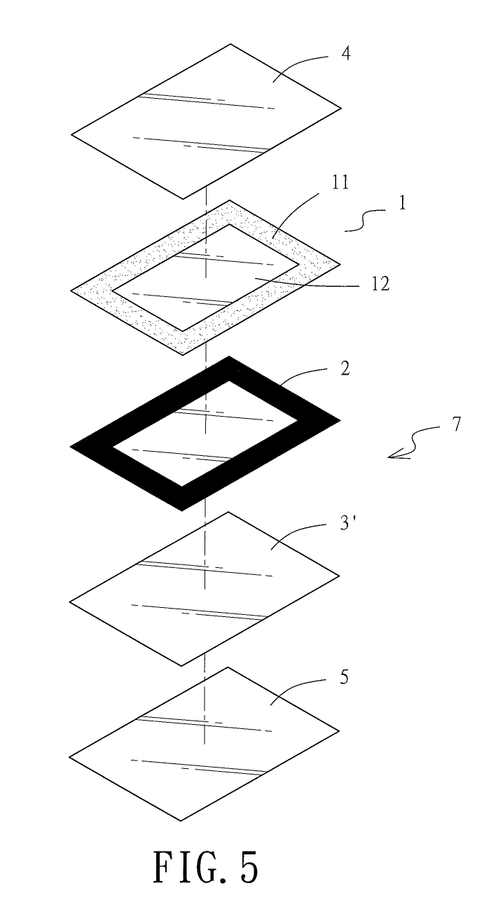

The screen protector of the present invention can also provide a privacy protection function. Referring to FIG. 5, a screen protector 7 capable of privacy protection and applicable to the screen of a portable information or communication device (e.g., iPad, iPhone, MacBook, etc.) includes a PET film 1, a printed black-frame film 2, a privacy protection film 3′, a PET release film 4, and a PE protective film 5.

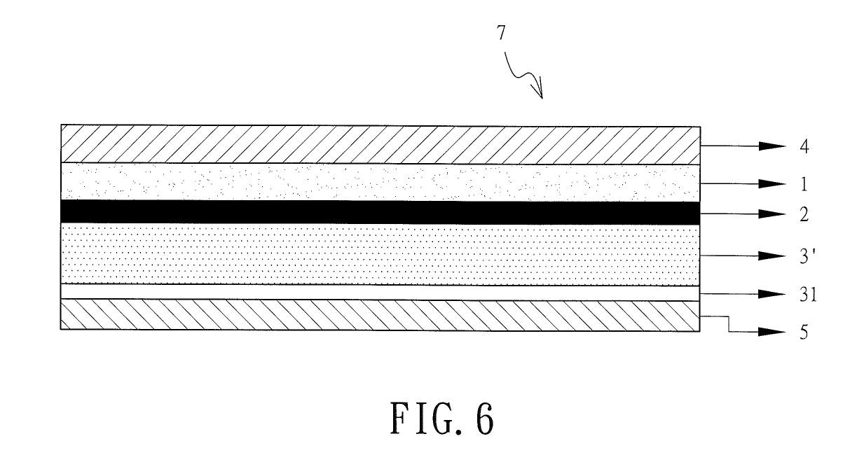

The PET film 1 has a printed area 11 around its periphery and a transparent area 12 in the center, wherein the printed area 11 is capable of electrostatic attraction. The printed black-frame film 2 has a frame-like area around its periphery, wherein the frame-like area is coated in the desired color and corresponds in shape to the printed area 11 around the periphery of the PET film 1. It should be pointed out that the desired color is not necessarily black and can be the color of the housing of a device to which the screen protector 7 is to be applied or a different color. The privacy protection film 3′ is commercially available. Referring to FIG. 6, the screen protector 7 is formed by bonding the PET film 1 and the privacy protection film 3′ to opposite sides of the printed black-frame film 2 respectively are then bonding the PET release film 4 and the PE protective film 5 to the outer side of the PET film 1 and outer side of the privacy protection film 3′ respectively.

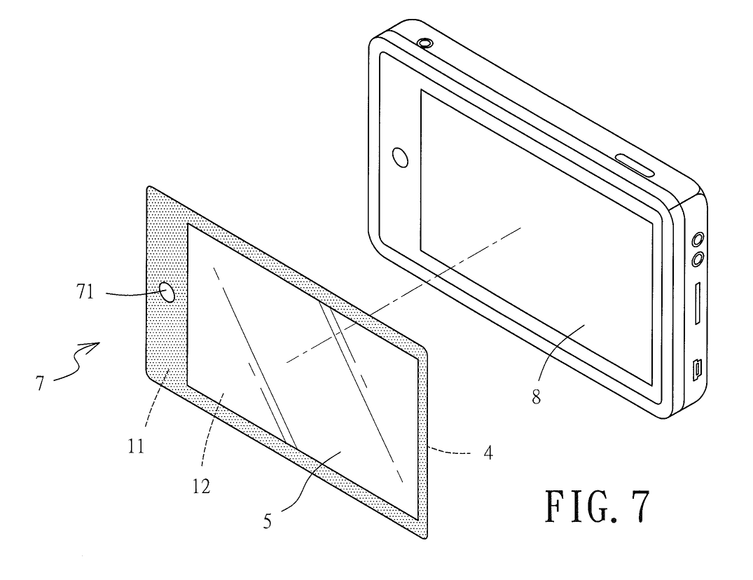

As shown in FIG. 6, it is also feasible to bond an additional hardened layer 31 to the outer side of the privacy protection film 3′ so that, once the screen protector 7 capable of privacy protection is applied to a screen 8 (see FIG. 7), the screen 8 is better protected against scratching.

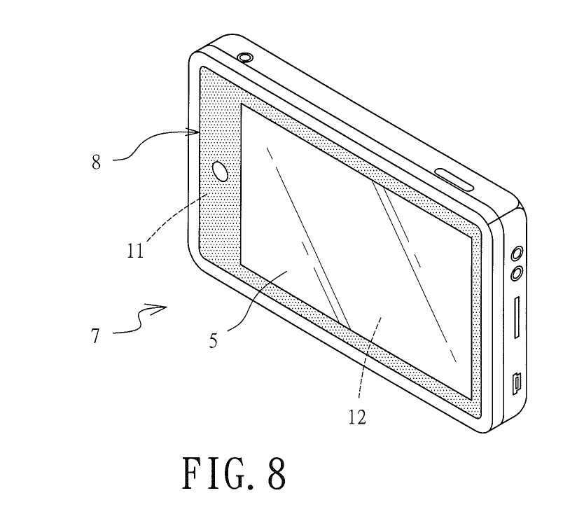

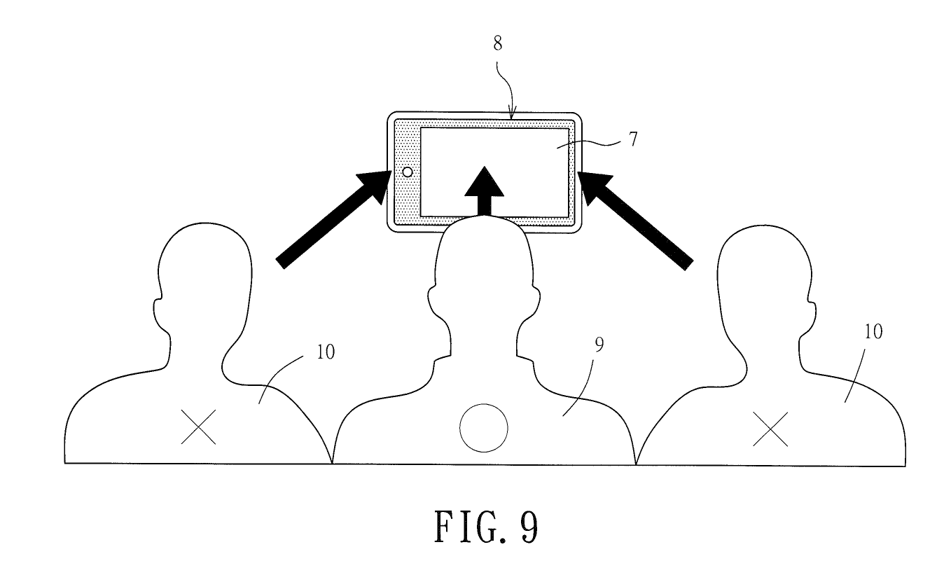

Referring to FIG. 7, the screen protector 7 capable of privacy protection can be cut according to the size of the screen 8 (e.g., the screen of an iPad) and formed with a hole 71 at a predetermined position. To apply the screen protector 7 to the screen 8, the PET release film 4 is peeled off, allowing the printed area 11 around the periphery of the PET film 1 to electrostatically attract and hence attach to the screen 8, as shown in FIG. 8. Thus, the screen protector 7 is compliantly and conveniently applied to the screen 8. The PE protective film 5 on the outer side of the screen protector 7 is subsequently peeled off. Referring to FIG. 9, when an information or communication device whose screen 8 is covered with the screen protector 7 capable of privacy protection is used in public, only the user 9, who is right in front of the screen 8, can view the screen images clearly; the screen 8 will look black to people 10 around the user 9 to ensure the user 9's privacy. Furthermore, the screen protector 7 capable of privacy protection can be easily removed for storage when not in use.

If the PET film 1 fails to provide adequate electrostatic attraction when the screen protector 7 is reused, all that needs to be done is to rub the PET film 1 or wash it with water, and the printed area 11 around the periphery of the PET film 1 will restore its electrostatic attraction.

What is claimed is:

1. A screen protector, comprising an inner polyethylene terephthalate (PET) film, a printed black-frame film, an outer PET film, a PET release film, and a polyethylene (PE) protective film, the inner PET film having a printed peripheral area capable of electrostatic attraction and a transparent central area, the printed black-frame film having a frame-shaped peripheral area which is coated in a desired color and corresponds in shape to the printed peripheral area of the inner PET film, the screen protector being formed by bonding the inner PET film and the outer PET film to opposite sides of the printed black-frame film respectively and then bonding the PET release film and the PE protective film to an outer side of the inner PET film and an outer side of the outer PET film respectively, wherein the screen protector can be cut according to a size of a screen and formed with a hole at a predetermined position, and wherein the screen protector is applied to the screen by peeling off the PET release film and allowing the printed peripheral area of the inner PET film to electrostatically attract and thereby attach to the screen such that the screen protector is applied completely compliantly to the screen without bubbles formed therebetween.

2. The screen protector of claim 1, wherein the outer side of the outer PET film is further bonded with a hardened layer so as to provide enhanced anti-scratch protection to the screen to which the screen protector is applied.

3. The screen protector of claim 1, wherein the outer PET film is a transparent film.

4. The screen protector of claim 1, wherein the outer PET film is a matte film.

5. A screen protector capable of privacy protection, comprising a polyethylene terephthalate (PET) film, a printed black-frame film, a privacy protection film, a PET release film, and a polyethylene (PE) protective film, the PET film having a printed peripheral area capable of electrostatic attraction and a transparent central area, the printed black-frame film having a frame-shaped peripheral area coated in a desired color and corresponding in shape to the printed peripheral area of the PET film, the screen protector being formed by bonding the PET film and the privacy protection film to opposite sides of the printed black-frame film respectively and then bonding the PET release film and the PE protective film to an outer side of the PET film and an outer side of the privacy protection film respectively, wherein the screen protector can be cut according to a size of a screen and formed with a hole at a predetermined position, and wherein the screen protector is applied to the screen by peeling off the PET release film and allowing the printed peripheral area of the PET film to electrostatically attract and thereby attach to the screen such that the screen protector is applied compliantly to the screen, the screen protector being removable for storage when not in use.

6. The screen protector of claim 5, wherein the outer side of the privacy protection film is further bonded with a hardened layer so as to provide enhanced anti-scratch protection to the screen to which the screen protector is applied.
